(19) United States
(12) Patent Application Publication
(10) Pub. No.: US 2012/0215565 A1
(43) Pub. Date: Aug. 23, 2012

(54) SYSTEMS AND METHODS FOR GATHERING AND STORING PHYSICAL ATTRIBUTES ABOUT A PHYSICAL STRUCTURE

(75) Inventor: Daniel Ander, Bellevue, WA (US)

(73) Assignee: Washington Survey and Rating Bureau, Seattle, WA (US)

(21) Appl. No.: 13/397,451

(22) Filed: Feb. 15, 2012

Related U.S. Application Data
(60) Provisional application No. 61/443,949, filed on Feb. 17, 2011.
(60) Provisional application No. 61/443,938, filed on Feb. 17, 2011.

(51) Int. Cl. G06Q 40/08

(52) U.S. Cl. 705/4

(57) ABSTRACT

A system and method for determining insurance rates and loss costs for properties generally, and for physical structures specifically includes receiving a request for an inspection of real property, providing an interface configured to provide an inspector with one or more first prompts related to the inspection of real property, providing one or more second prompts in the interface as a result of received response to the one or more first prompts related to the inspection of real property, and generating an inspection report based on the received response to the first and second prompts.

### CROSS REFERENCE TO RELATED APPLICATIONS

This application claims priority to US Provisional Patent Application No. 61/443,949, including its appendix A, filed on Feb. 17, 2011, and US Provisional Patent Application No. 61/443,938, including its Appendices A-C, filed on Feb. 17, 2011, both of which are hereby incorporated by reference in their entirety.

### COPYRIGHT NOTICE

This disclosure is protected under United States and International Copyright Laws, © 2012 Washington Survey and Rating Bureau. All Rights Reserved. A portion of the disclosure of this patent document contains material which is subject to copyright protection. The copyright owner has no objection to the facsimile reproduction by anyone of the patent document or the patent disclosure after formal publication by the U.S. Patent Office, as it appears in the U.S. Patent and Trademark Office patent file or records, but otherwise reserves all copyright rights whatsoever.

### FIELD OF THE INVENTION

The present disclosure relates to systems and methods for determining insurance rates and loss costs for properties generally, and for physical structures specifically.

### BACKGROUND OF THE INVENTION

Typically, when inspecting a physical structure to determine property insurance rates and loss costs, a field representative observes the relevant attributes as set forth in the General Basic Schedule (GBS) and Washington Supplement (Supplement), or other related schedules and supplements in other states and jurisdictions, and records them in informal notes. The field representative then returns to their office or home and transcribes the informal notes to a form. The field representative then generally uses the values and formulas in the GBS and the Supplement to manually calculate charges and credits and derive summary characteristics such as overall construction, for example, associated with the attributes and then enters them on the form. Finally, using the calculated charges and credits and summary characteristics along with additional values, schedules and formulas from the GBS and Supplement the field representative may manually calculate a Loss Cost for the Property and its Occupants. Other such schedules exist, such as the Specific Commercial Property Evaluation Schedule. Using the property inspection and relevant schedules, a final rate/loss cost is then manually calculated or the appropriate charges and credits can be entered into a computer application for automated calculation and publication.

Errors are frequently introduced into the calculation process at several steps along the way: the field representative's notes may be misinterpreted at the time of charge/credit selection, the field representative may choose the wrong charge/credit due to an incorrect or subjective interpretation of certain rules, and mathematical errors can occur in manual calculations. The extensive use of free form text in the form allows for inconsistent (or even inaccurate) descriptions of attributes and conditions making interpretation and automated processing of the data difficult. Further, the process of determining the proper credit/charges is subjective and labor-intensive, because the process itself is repeated every time by the field representative for each building inspected.

Generally, analyzing catastrophic insurance risk involves analyzing the subject of the insurance policy in relation to the natural and man-made hazards present or proximate; it can also involve identifying and estimating the total loss potential catastrophic events can have on a portfolio of policies. Geographic Information Systems (GIS) exist which can analyze a subject or group of subjects and provide a summary report of catastrophic risk; however, these systems lack the ability to perform scenario-based analysis through interaction with the system, and they lack the ability to perform and export ad-hoc analysis based on the individual user's data sets and their relation to the hazard data stored by the system.

Accordingly, there is a need to reduce the errors, labor intensity and inconsistencies associated with present systems and methods for gathering and analyzing information about physical structures for the purpose of determining property insurance rates and loss costs. Additionally, there is a need for more robust catastrophic risk reporting than is currently available with Graphical Information Systems.

### BRIEF DESCRIPTION OF THE DRAWINGS

Preferred and alternative examples of the present invention are described in detail below with reference to the following drawings:

FIG. 1 is a flowchart showing an overview of an embodiment of a physical structure evaluation system;

FIG. 2 is a flowchart showing a workflow of an embodiment of a physical structure evaluation system;

FIG. 3 shows a sample inspection or commercial property report as produced by one or more embodiments of the current invention;

FIG. 4 is a block diagram of a property exposure analysis system in accordance with an alternative embodiment of a physical structure evaluation system; and,

FIG. 5 is a block diagram of a computing device suitable for practicing the property exposure analysis system illustrated in FIG. 4.

### DETAILED DESCRIPTION OF THE PREFERRED EMBODIMENT

In the following description, certain specific details are set firth in order to provide a thorough understanding of various embodiments of the invention. However, one skilled in the art will understand that the invention may be practiced without these details or with various combinations of these details. In other instances, well-known systems and methods associated with, but not necessarily limited to, collection of at least one of physical attributes about a building, occupancies, protective features, external exposures and methods for operating the same may not be shown or described in detail to avoid unnecessarily obscuring descriptions of the embodiments of the invention.

It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention are operational with numerous general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

In one embodiment, the systems and methods as described herein are designed to automate the collection of physical attributes and facts about a building's construction, occupancies, protective features, and external exposures, and to use the collected information to automatically calculate and publish a property insurance rate or loss cost for the building and its occupants.

One or more embodiments of the invention include, but are not limited to a process for gathering and storing attributes about physical structures (“inspections”); associating each attribute or configuration of attributes with a specific charge or credit value; assessing multiple attributes to arrive at a summary characteristic; combining charges and credits to calculate Loss Costs; and doing all of the foregoing precisely, accurately, and consistently according to the specified rules; and producing standardized outputs of collected and calculated values for immediate viewing over the Internet, reporting and inclusion in other key business processes.

An embodiment of the software described herein uses a (1) Microsoft SQL server database, however one skilled in the art would understand other such databases could be used, (2) Geographic Information Systems (“GIS”) geodatahases and software, (3) software algorithms, (4) mobile computing platform or digital entry device, and (5) a third-party drawing software program for recording a diagram of the inspected building. The mobile computing platform may also include a wired or wireless connection to the Internet to upload the data to remote servers which can be instructed to immediately send inspection and other data to remote servers and initiate the calculation, summarization and publication of the inspection results and notify requesting customers of its completion.

One or more software embodiments are advantageous because such an embodiment may include an expression of certain “best practices” in business process management, in that it applies the “once and done” philosophy to a process that previously required redundant and error-prone data entry, manual look-ups, and subjective interpretations. Software embodiments further include logic to assist inspectors on location (e.g., in the field). It replaces prior art inefficient processes with a device that a field representative may use to observe and record certain features and conditions of buildings and more so transforms the input data into meaningful data that can be used to calculate costs and credits.

In some embodiments, once all the necessary features and conditions are recorded in the system, the publication of reports and rating information is complete preferably no analysis of the charges and credits to be applied need be done by the field representative, either in the field or in the office; preferably no recording of the charge and credit values into a database need be done; preferably no additional reports need to be written. In other embodiments, the representative may modify the report based on the outputs and known conditions. Also the system may include other methods and/or algorithms to adjust the output based on location, proximity, age etc.

By way of example, in some scenarios a necessary piece of information in assigning an insurance rate to a building is knowing how many floors (stories) the building has. Once this has been determined, a table may be consulted to determine the proper charge value to enter onto a rating form or into a database. It may be that other conditions can affect which value to use, so the person recording the value must review other relevant building attributes to determine whether they have an impact on the correct value to use. Assigning the correct value using this method is highly error-prone, because it may be necessary to evaluate many seemingly unrelated attributes and conditions; intermediate computations and analyses (both subjective and objective) may be required and may be revised as the process continues and more information is evaluated. This adds to the potential of losing track of one or more of the attributes necessary for a correct computation. An embodiment of the current invention advantageously eliminates the laborious and iterative process of assigning charge/credit values by prompting the field representative only to observe and record attributes and conditions. Once attributes or conditions are entered, the system may advantageously prompt the field representative with other questions or prompt the representative with other inputs. The inputs being dynamically generated based on entered attributes and/or conditions. Most, if not all the rules, table values and dependencies are embodied in software algorithms. As long as the field representative accurately gathers and records the required attributes and conditions, the software will correctly store, manipulate, and publish the results of the inspection.

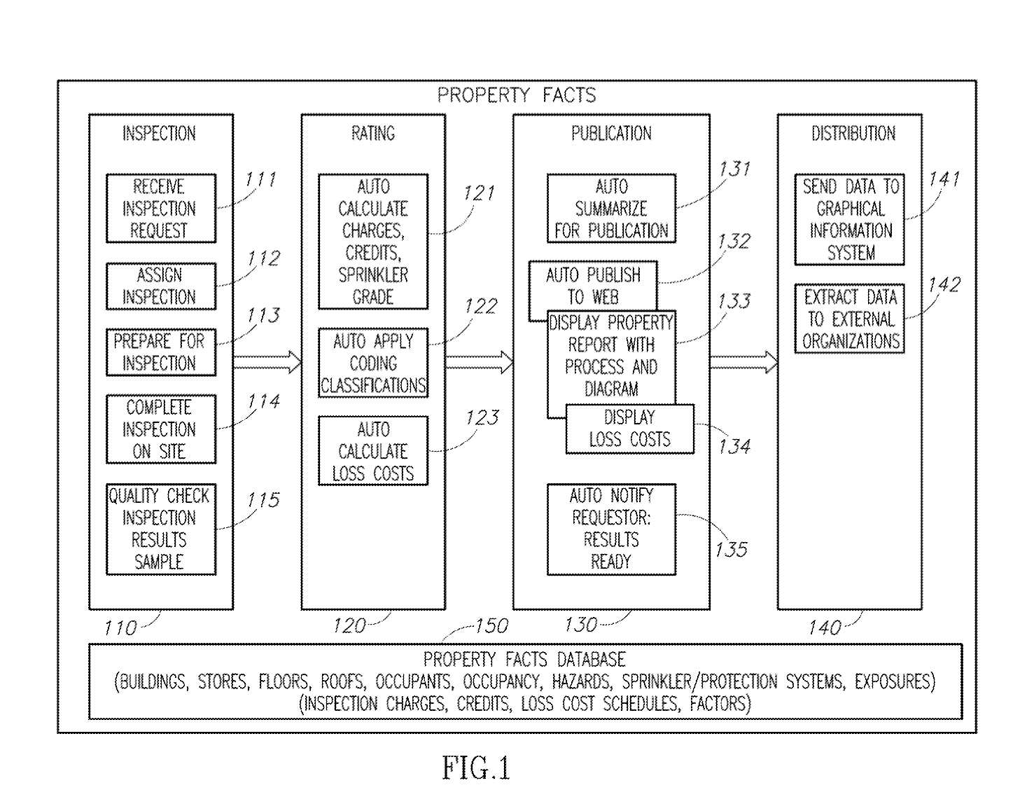

FIG. 1 is a flowchart showing an overview of an embodiment of a physical structure evaluation system. FIG. 1 includes an inspection 110, rating 120, publication 130 and distribution 140. Inspection 110 includes receiving an inspection request 111, assigning the inspection request to a field representative 112, preparing the field representative for the inspection 113, the representative completing the inspection 114 and checking the inspection for quality 115. Rating 120 includes the automatic calculation of charges 121, credits sprinkler grades etc., automatically applying various coding classifications 122, and automatically calculating loss costs 123. Publication 130 includes, summarizing the inspection for publication 131, publishing the inspection to a publically available medium such as a website 132, the publication including photographs as well as other relevant inspection representations and media 133, loss costs 134, and notifying a requester of the inspection that the results are ready 135. Distribution 140 includes transmitting data to one or more graphical information systems 141 and external organizations 142.

Inspection 110, Rating 120, Publication 130 and Distribution 140 are all preferably in data communication with a property facts database 150, that contains buildings, stories, roofs, occupants, occupancy hazards, sprinkler/protection systems, exposures, inspection charges, credits, loss cost schedules, and/or factors data as well as other data related to evaluation of a physical structure.

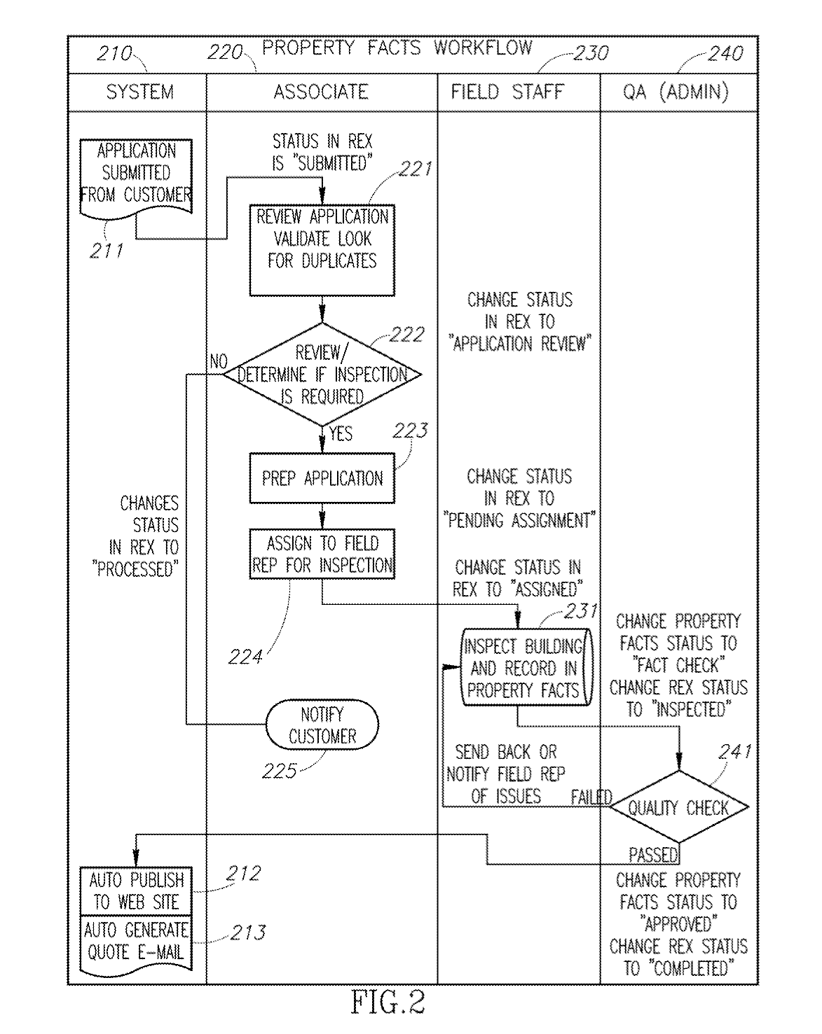

FIG. 2 is a flowchart showing a workflow of an embodiment of a physical structure evaluation system. The physical structure evaluation system includes a system 210, interaction with an associate 220, interaction with field staff 230 and quality assurance (QA) 240. The system 210 is configured to receive an application from a customer 211, and is further configured to publish completed reports to a web site 212. In some embodiments the system 210 is configured to generate bids/quotes for completing an inspection 213. The associate 220 preferably interacts with the system 210 to review a submitted application (to include checking for duplicates) 221, review/determine if inspection is required 222, and if one is, then prepares an application 223 and assigns to a field representative or staff for inspection 224. If review step 222 determines an inspection is not required, the associate 220 notifies the customer 225. The field staff 230 preferably inspects a building and records the data 231 into the system 210. Quality assurance 240 is comprised of review and quality check procedures 241, that when approved (Passed) returns the inspection to the system 210 and if not approved (Failed), the inspection is returned to the field staff 230.

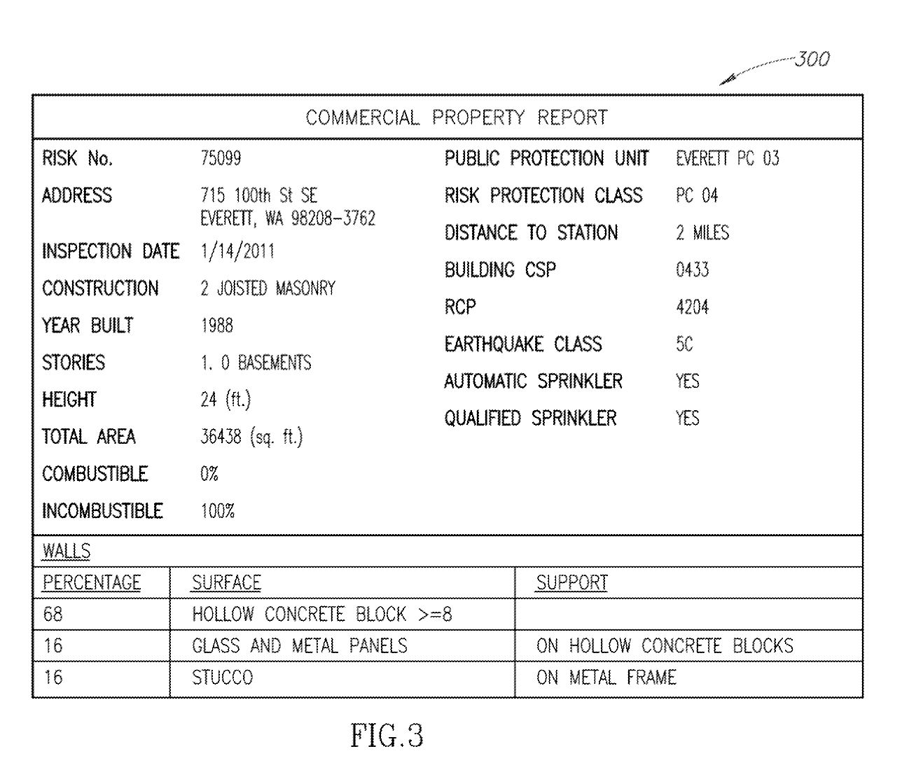

FIG. 3 shows a sample inspection or commercial property report 300 as produced by one or more embodiments of the current invention.

In an alternative embodiment, systems and methods for analyzing real properties against location-based criteria includes the analysis of a real property address. The real property address can be input as a single address or as a batch of addresses that are constantly monitored (i.e., interactive, at the user's control) by a user. The system and method further includes the ability to allow users, such as insurance agents and brokers, to evaluate physical risk and catastrophic risk for the real property addresses. In some embodiments geographic information system technology is used to display geographic risk factors as layers on a map. For example, when a user enters an address, the address is geo-coded and plotted on a map. The location is then analyzed to determine if there other data layers available, such as tsunami, flood, volcanic mud flow, wild land/vegetation, demographics and earthquake maps. A user can then interact with the map by turning on or off the available risk and demographic layers. A user can further view the fire protection and code enforcement services in the area and how they related to nationally-recognized standards. In some embodiments, a user's own rating tables can be used to determine risk. A summary report based on the interactive selections made by the user (contains risks hazards, demographics, their data, book of business) is also available to the user.

Embodiments of the current invention are advantageous with regard to insurance application intake and underwriting risk management; marketing and/or agent support. Application intake and underwriting further includes address validation, accurate initial rating, pricing and tax remittance; informed selection and to avoid premium leakage. Risk management further includes natural disasters, reinsurance, resource planning, terrorism risk and/or financial exposure. Marketing further includes location of best customers, prospecting, cross selling opportunities, targeted and demographic marketing, campaign management and/or strategic planning. Agent support further includes recruitment, territory penetration, and/or straight-through application processing.

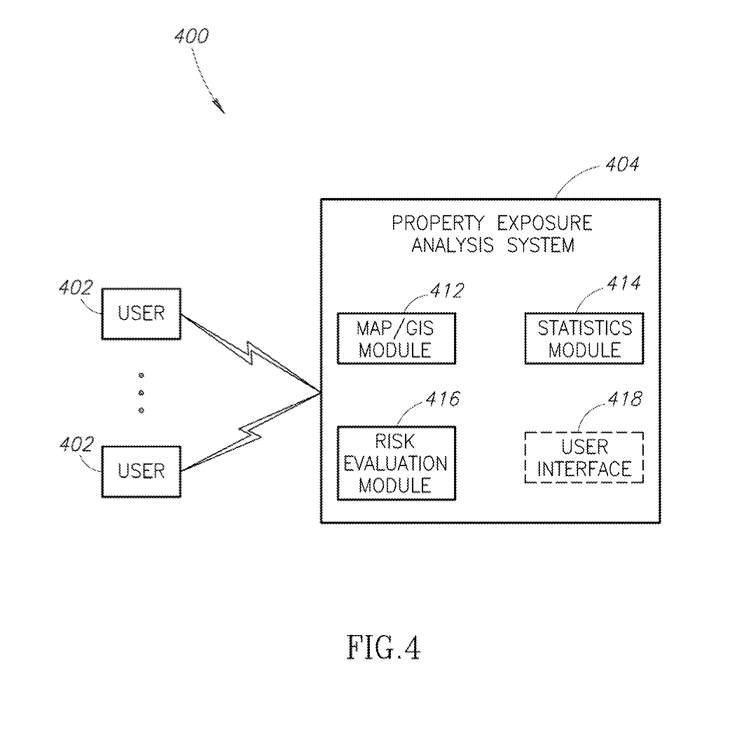

FIG. 4 is a block diagram of components of a property exposure analysis system in accordance with an embodiment of the present invention. FIG. 4 depicts an example risk analysis environment 400 that includes one or more users 402 and a property exposure analysis system 404. The components of the illustrated property exposure analysis system 404 provide various logic (e.g. code, instructions, functions, routines, etc.) and/or services related to analyzing risk factors of a known property or properties. The property exposure analysis system 404 includes, but is not limited to, a map/GIS (Geographic Information System) module 412, a statistics module 414, a risk evaluation module 416 and a user interface 418.

An example embodiment of an example Map/GIS module 412 enables a user 402 to search by address, public land survey, latitude and longitude as well as other known location tools. The Map/GIS module 412 provides mapping data in various formats such as street view, earth view, map view, parcel view, as well as other generally known mapping software and imagery. The example Map/GIS module 412 may also switch between street and imagery views and/or a blend of both.

An example embodiment of a statistics module 414 provides a user with information relating to ratings, classification, geographic and demographic information related to one or more property locations. Ratings include but are not limited to territory codes for dwellings and commercial properties. Classifications include, but are not limited to data related to a related city/fire district, responding fire department, and fire station distance. Other information includes fire hydrants in the vicinity of the property. Other information about fire stations is available. Geographic information includes, but is not limited to, geographic features of a particular location such as distances to a fault line, FEMA flood zones, liquefaction exposure, vegetation percent and wild land urban interfaces, amongst other related geographic information. Demographic information includes, but is not limited to population and economic statistics in a vicinity of a particular location. Such statistics include income, household size, transportation use, population age, and other related geographic data.

An example embodiment of a risk evaluation module 416 enables a user to determine risk by activating the statistics module 414 in conjunction with the risk evaluation module 416 so as to view a property location on a map in the user interface 418, and further enabling the user to activate layers that graphically display the data present in the statistics module 414. By activating layers the risk evaluation module 416 allows a user to see various risks visually and then evaluate a property or group of properties accordingly.

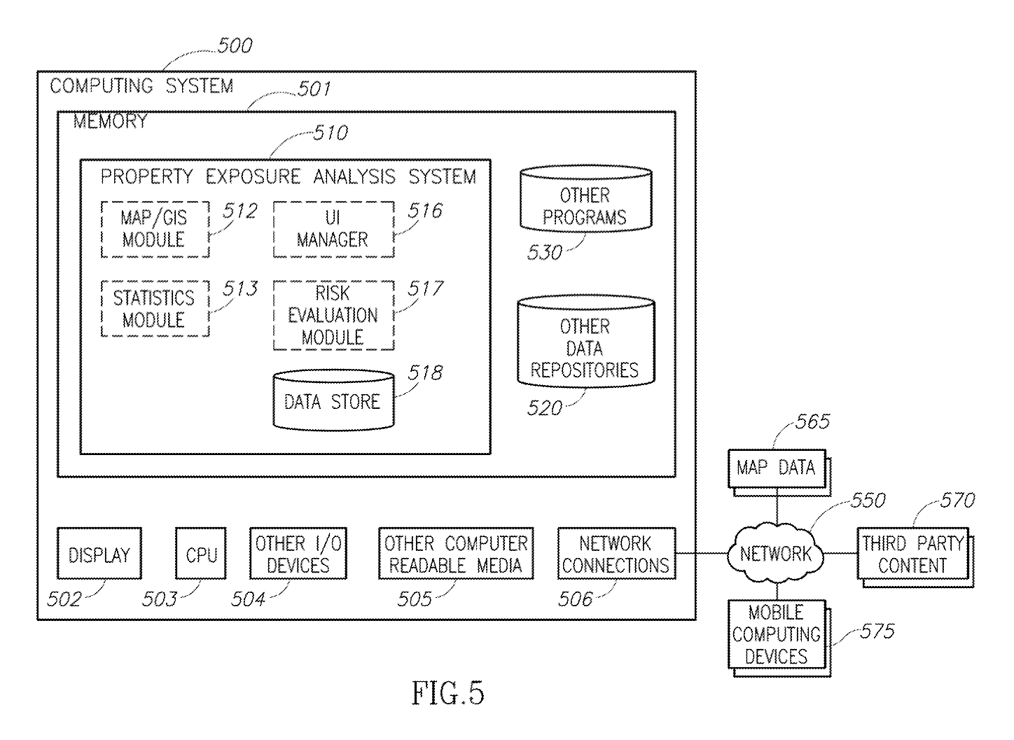

FIG. 5 is a block diagram of an example computing device for practicing property exposure analysis in accordance with an embodiment of the present invention. In particular, FIG. 5 shows a computing system 500 that may be utilized to implement a property exposure analysis system 510. It is understood that one or more general purpose or special purpose computing systems/devices may be used to implement the property exposure analysis system 510. In addition, the computing system 500 may comprise one or more distinct computing systems/devices and may span distributed locations. Furthermore, each block shown may represent one or more such blocks as appropriate to a specific embodiment or may be combined with other blocks. Also, the property exposure analysis system 510 may be implemented in software, hardware, firmware, or in some combination to achieve the capabilities described herein.

In the embodiment shown in FIG. 5, computing system 500 comprises a computer memory (“memory”) 501, a display 502, one or more Central Processing Units (“CPU”) 503, Input/Output devices 504 (e.g., keyboard, mouse, CRT or LCD display, and the like), other computer-readable media 505, and network connections 506. The property exposure analysis system 510 is shown residing in memory 501. In other embodiments, some portion of the contents, some or all of the components of the property exposure analysis system 510 may be stored on and/or transmitted over the other computer-readable media 505. The components of the property exposure analysis system 510 preferably execute on one or more CPUs 503 and extract and provide quotations, as described herein. Other code or programs 530 (e.g., an administrative interface, a Web server, and the like) and potentially other data repositories, such as data repository 520, also reside in the memory 501, and preferably execute on one or more CPUs 503. Of note, one or more of the components in FIG. 5 may not be present in any specific implementation. For example, some embodiments may not provide other computer readable media 505 or a display 502.

In a typical embodiment, as described above, the property exposure analysis system 510 includes a map/GIS module 512, a statistics module 513, a risk evaluation module 517 and a UI manager 516. An example embodiment of each of the proceeding (512, 513, 516, 517) is further explained with reference to FIG. 4.

The property exposure analysis system 510 interacts via the network 550 with (1) map data 565, (2) third party content 570 and/or (3) mobile computing devices 575. The network 550 may be any combination of media (e.g., twisted pair, coaxial, fiber optic, radio frequency), hardware (e.g., routers, switches, repeaters, transceivers), and protocols (e.g., TCP/IP, UDP, Ethernet, WiMAX) that facilitate communication between remotely situated humans and/or devices. The mobile computing devices 575 include, but are not limited to desktop computing systems, notebook computers, mobile phones, smart phones, personal digital assistants, and the like.

In an example embodiment, components/modules of the property exposure analysis system 510 are implemented using standard programming techniques. For example, the property exposure analysis system 510 may be implemented as a “native” executable running on the CPU 503, along with one or more static or dynamic libraries. In other embodiments, the property exposure analysis system 510 may be implemented as instructions processed by a virtual machine that executes as one of the other programs 503. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the property exposure analysis system 510, can be made available by standard mechanisms such as through C, C#, and Java APIs, libraries for accessing files, databases, or other data repositories; through languages such as XML; or through Web servers, FTP servers, or other types of servers providing access to stored data. The data store 518 may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the property exposure analysis system 510 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

As stated above, Appendix A previously incorporated by reference in Provisional Application No. 61/443,949, and Appendices A-C previously incorporated by reference in Provisional Application No. 61/443,938, are further incorporated herein by reference.

From the foregoing it will be appreciated that, although specific embodiments have been described herein for purposes of illustration, various modifications may be made without deviating from the spirit and scope of the invention. For example, the methods and systems for a property exposure analysis system discussed herein are applicable to other architectures other than a web based architecture or related to property risk analysis. Also, the methods and systems discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, etc.).

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A system for collecting property based information, comprising:
an inspection module for gathering information related to a physical structure; and,
a rating module for calculating an insurance rate for the physical structure based on the information gathered with the inspection module.

2. The system of claim 1, further comprising:
a publication module for publishing the information gathered with the inspection module; and,
a distribution module for distributing the published information to a graphical information system.

3. The system of claim 2, wherein the information gathered with the inspection module is published to a publically available medium.

4. A method for collecting property-based information comprising the steps of:
receiving a request for an inspection of real property;
providing an interface configured to provide an inspector with one or more first prompts related to the inspection of real property;
providing one or more second prompts in the interface as a result of received response to the one or more first prompts related to the inspection of real property; and,
generating an inspection report based on the received response to the first and second prompts.

5. A property exposure analysis system, comprising:
a map module that provides location and mapping data for at least one property;
a statistics module that provides at least one of geographic information and demographic information for the located at least one property; and,
a risk evaluation module that provides risk-related information for the at least one property based on at least one of the geographic information and demographic information.

6. The system of claim 5, wherein the map module is a graphical information system.

7. The system of claim 5, wherein the geographic information provided by the statistics module includes data for at least one of a fault line, FEMA flood zone, liquefaction exposure, vegetation and wild land-urban interfaces.

8. The system of claim 7, wherein the demographic information provided by the statistics module includes at least one of population statistics and economic statistics in the vicinity of the located at least one property.

9. The system of claim 8, wherein the population statistics and economic statistics at least one of income, household size, transportation use and population age related data.
